(19) United States
(12) Patent Application Publication
(10) Pub. No.: US 2014/0258613 A1
(43) Pub. Date: Sep. 11, 2014

(54) VOLUME CHANGE FLAGS FOR INCREMENTAL SNAPSHOTS OF STORED DATA

(71) Applicant: LSI CORPORATION, San Jose, CA (US)

(72) Inventor: Kishore K. Sampathkumar, Bangalore (IN)

(73) Assignee: LSI CORPORATION, San Jose, CA (US)

(21) Appl. No.: 13/970,907

(22) Filed: Aug. 20, 2013

(30) Foreign Application Priority Data
Mar. 8, 2013 (IN) 1006CHE2013

(51) Int. Cl. G06F 12/00

(52) U.S. Cl. CPC G06F 12/00
USPC 711/114

(57) ABSTRACT

Methods and structure are provided for tracking changes to a logical volume over time. One exemplary embodiment is a backup system for a Redundant Array of Independent Disks (RAID) storage system. The backup system includes a backup storage device that includes Copy-On-Write snapshots of a logical volume of the storage system. The backup system also includes a backup controller. The backup controller is able to maintain flags for the logical volume that indicate whether extents at the logical volume have been modified since a previous snapshot was created, and to move the flags from the logical volume to a new Copy-On-Write snapshot of the volume when the new Copy-On-Write snapshot is created. This preserves information describing which extents of the logical volume changed between the creation of the new snapshot and the previous snapshot.

### CROSS REFERENCE TO RELATED APPLICATIONS

This document claims priority to Indian Patent Application Number 1006/CHE/2013 filed on Mar. 8, 2013 (entitled VOLUME CHANGE FLAGS FOR INCREMENTAL SNAPSHOTS OF STORED DATA) which is hereby incorporated by reference

### FIELD OF THE INVENTION

The invention relates generally to storage systems, and more specifically to backup technologies for storage systems.

### BACKGROUND

Redundant Array of Independent Disks (RAID) storage systems use Copy-On-Write techniques to reduce the size of backup data for a logical volume. When Copy-On-Write is used, each snapshot of the logical volume at a point in time is initially generated as a set of pointers to blocks of data on the logical volume itself. After the snapshot is created, if a host attempts to write to the logical volume, the blocks from the logical volume that will be overwritten are copied to the snapshot. This ensures that the snapshot occupies little space, but still includes accurate data for the point in time at which it was taken. The snapshot therefore “fills in” with data that has been overwritten in the logical volume. By combining data from the Copy-On-Write snapshot and the logical volume, the storage system can change the logical volume to a state it was in at the time the snapshot was taken.

### SUMMARY

The present invention tracks, on a snapshot-by-snapshot basis, whether the data for a logical volume has actually changed across multiple snapshots. This helps to ensure that systems that allow writes to Copy-On-Write snapshots of a volume can determine which changes were made to the volume itself, and which changes were made directly to the snapshots.

One exemplary embodiment is a backup system for a Redundant Array of Independent Disks (RAID) storage system. The backup system includes a backup storage device that includes Copy-On-Write snapshots of a logical volume of the storage system. The backup system also includes a backup controller. The backup controller is able to maintain flags for the logical volume that indicate whether extents at the logical volume have been modified since a previous snapshot was created, and to move the flags from the logical volume to a new Copy-On-Write snapshot of the volume when the new Copy-On-Write snapshot is created. This preserves information describing which extents of the logical volume changed between the creation of the new snapshot and the previous snapshot.

Other exemplary embodiments (e.g., methods and computer readable media relating to the foregoing embodiments) may be described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of an exemplary storage system.

FIG. 2 is a flowchart describing an exemplary method for backing up a logical volume.

FIG. 3 is a flowchart describing an exemplary method for rebuilding a logical volume.

FIGS. 4-12 are block diagrams illustrating the creation and maintenance of multiple Copy-On-Write snapshots of a logical volume in an exemplary embodiment.

FIG. 13 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

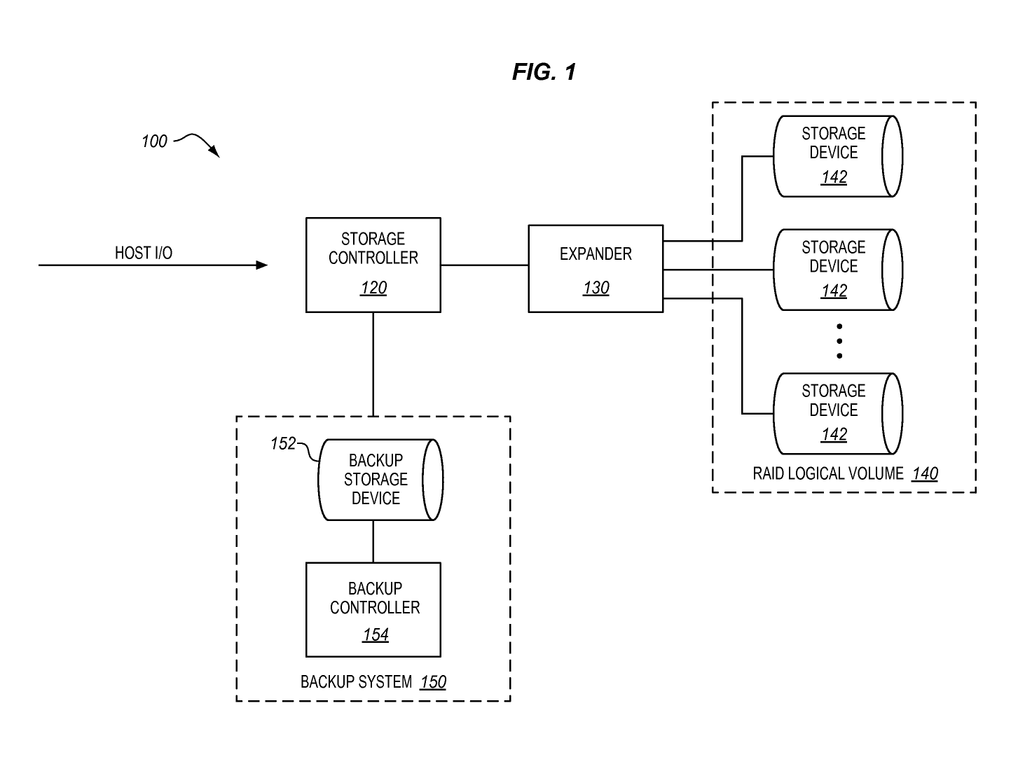

FIG. 1 is a block diagram of an exemplary Redundant Array of Independent Disks (RAID) storage system 100. Storage system 100 receives incoming Input/Output (I/O) operations from one or more hosts, and performs the I/O operations as requested to change or access stored digital data on one or more RAID logical volumes such as RAID volume 140.

Storage system 100 implements enhanced backup system 150. Backup system 150 maintains one or more Copy-On-Write snapshots of logical volume 140. Backup system 150 may also directly write to any of the snapshots to alter the data stored on those snapshots, even if logical volume 140 itself has not been modified. For example, backup system 150 may write to a snapshot in response to receiving host I/O that is specifically directed to the stored snapshot (instead of logical volume 140). In most backup systems, once a snapshot has been directly written to, there is no way of knowing how the logical volume itself was modified over time. For example, during a rebuild of the volume, it becomes unclear whether the change to the snapshot was also a change to the logical volume. There is simply no way to know whether the change to the snapshot intended to back up the logical volume or not.

In order to address this problem, backup system 150 has been modified to implement tracking flags that indicate whether extents of logical volume 140 have actually changed between snapshots.

According to FIG. 1, storage system 100 comprises storage controller 120, which manages RAID logical volume 140. As a part of this process, storage controller 120 may translate incoming I/O from a host into one or more RAID-specific I/O operations directed to storage devices 142-146. In one embodiment, storage controller 120 is a Host Bus Adapter (HBA).

In this embodiment, storage controller 120 is coupled via expander 130 with storage devices 142-146, and storage devices 142-146 maintain the data for logical volume 140. Expander 130 receives I/O from storage controller 120, and routes the I/O to the appropriate storage device. Expander 130 comprises any suitable device capable of routing commands to one or more coupled storage devices. In one embodiment, expander 130 is a Serial Attached Small Computer System Interface (SAS) expander.

While only one expander is shown in FIG. 1, any number of expanders or similar routing elements may be combined to form a switched fabric of interconnected elements between storage controller 120 and storage devices 142-146. The switched fabric itself may be implemented via SAS, Fibre Channel, Ethernet, Internet Small Computer System Interface (ISCSI), etc.

Storage devices 142-146 provide the storage capacity of logical volume 140, and read and/or write to the data of logical volume 140 based on I/O operations received from storage controller 120. For example, storage devices 142-146 may comprise magnetic hard disks, solid state drives, optical media, etc. compliant with protocols for SAS, Serial Advanced Technology Attachment (SATA), Fibre Channel, etc.

In this embodiment, RAID logical volume 140 of FIG. 1 is implemented using storage devices 142-146. However, in other embodiments logical volume 140 is implemented with a different number of storage devices as a matter of design choice. Furthermore, storage devices 142-146 need not be dedicated to only one logical volume, but may also store data for a number of other logical volumes.

Backup system 150 is used in storage system 100 to store Copy-On-Write snapshots of logical volume 140. Using these snapshots, backup system 150 can change the contents of logical volume 140 to revert the contents of the volume to a prior state. In this embodiment, backup system 150 includes a backup storage device 152, as well as a backup controller 154. Backup controller 154 may be implemented, for example, as custom circuitry, as a processor executing programmed instructions stored in program memory, or some combination thereof. In one embodiment, backup controller comprises an integrated circuit component of storage controller 120.

In some embodiments, the components of backup system 150 are integrated into expander 130 or storage controller 120. Furthermore, backup storage device 152 may be implemented, for example, as one of many backup storage devices available to backup controller 154 remotely through an expander. The particular arrangement, number, and configuration of components described herein with regard to FIG. 1 is exemplary and non-limiting.

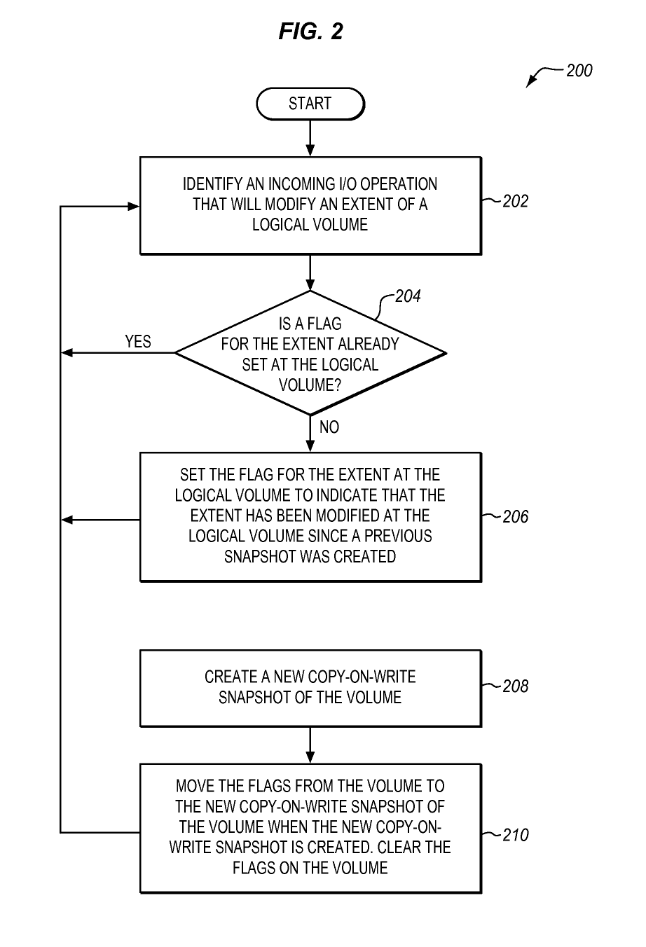

Details of the operation of backup system 150 will be described with regard to the flowchart of FIG. 2. Assume, for this operational embodiment, that RAID storage system 100 has initialized and is operating to perform host I/O operations upon the data stored in logical volume 140. Further, assume that backup controller 154 has generated multiple Copy-On-Write snapshots of logical volume 140 at earlier points in time, and each snapshot is stored at backup storage device 152. With this in mind, FIG. 2 is a flowchart describing an exemplary method 200 for backing up a logical volume.

In step 202, backup controller 154 identifies an incoming Input/Output operation that will modify an extent of logical volume 140. For example, backup controller may “snoop” incoming host I/O in order to detect such commands, such as write commands directed to an extent of the logical volume 140.

In step 204, backup controller 154 determines whether the flag for the extent that is about to be modified has already been set at the volume. The flags indicate which extents at logical volume 140 have been modified since the previous snapshot of logical volume 140 was created/taken. The flags therefore show how logical volume 140 has changed since the latest snapshot, and the flags also will not be corrupted or otherwise altered if a snapshot is directly modified by a user. Each flag corresponds to an extent at logical volume 140, and each snapshot (as well as logical volume 140 itself) has its own set of flags. The flags may be stored as a bitmap, as tags, or as any suitable form of data accessible to backup controller 154.

If the flag has already been set at logical volume 140 (i.e., if the corresponding flag kept at the logical volume has been set), then backup controller 154 continues monitoring for new incoming I/O operations. In keeping with Copy-On-Write standards, backup controller 154 may further perform Copy-On-Write operations to duplicate the data for the extent from logical volume 140 to one or more previous snapshots before the incoming I/O operation modifies the extent. In this manner, the extent can be preserved in the previous snapshot in the same form that it existed in when the previous snapshot was taken.

Alternatively, if the flag for the extent has not yet been at logical volume 140, backup controller 154 proceeds to step 206. In step 206, backup controller 154 sets the flag for the extent at logical volume 140. Copy-On-Write operations may then be performed to back up the data in the extent to one or more previous snapshots.

Steps 208-210 may occur at any time while steps 202-206 are being performed. In steps 208-210, the flag information is maintained in steps 202-206 is moved to a newly created snapshot for logical volume 140.

In step 208, backup system 150 (e.g., via backup controller 154) generates a new Copy-On-Write snapshot of RAID logical volume 140. The snapshot can be generated based on any suitable criteria (e.g., periodically over time, in response to a triggering event such as a host request, etc.), and the snapshot may be stored on one or more backup storage devices 152.

In step 210, backup controller 154 moves the flags from logical volume 140 to the new Copy-On-Write snapshot of logical volume 140. In one embodiment, once the new snapshot has been generated, the flags for each extent of logical volume 140 are copied to the new snapshot, and then cleared (e.g., zeroed out) at logical volume 140. Later, as each extent is modified at logical volume 140, the corresponding flags for the logical volume can again be set (e.g., set to one) to show how logical volume 140 has changed since the new snapshot was taken.

Even though the steps of method 200 are described with reference to storage system 100 of FIG. 1, method 200 may be performed in other systems. The steps of the flowcharts described herein are not all inclusive and may include other steps not shown. The steps described herein may also be performed in an alternative order.

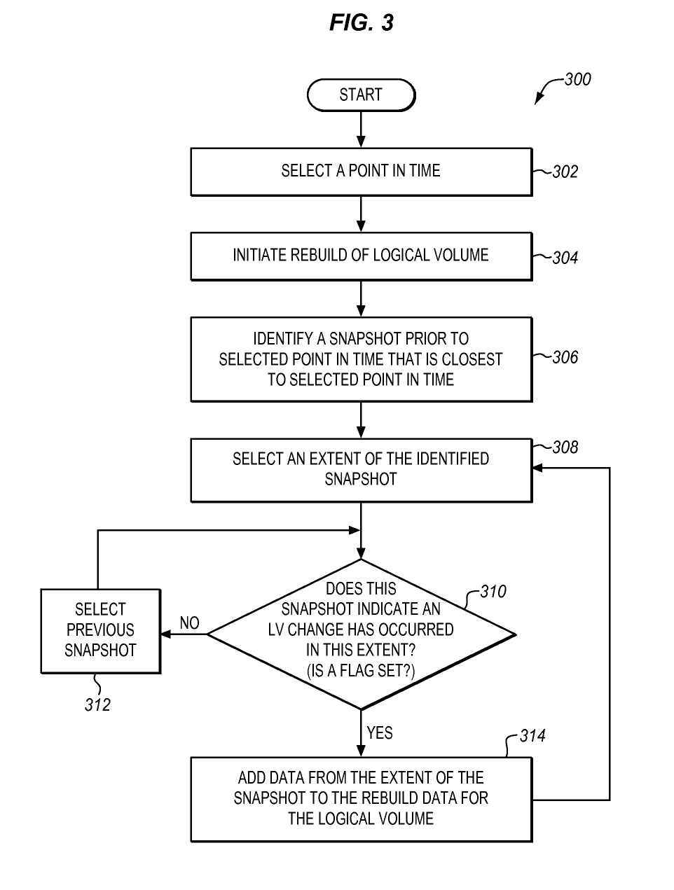

FIG. 3 is a flowchart describing an exemplary method 300 for rebuilding a logical volume. According to method 300, the flags of method 200 can be used to accelerate the rebuild process. In step 302, backup controller 154 selects a point in time to restore the logical volume to (e.g., based on user input selecting a specific time and/or snapshot).

In step 304, backup controller 154 initiates a rebuild of logical volume 140 (e.g., in response to a detected integrity error at logical volume 140, or in response to a host request). During the rebuild, in step 306 backup controller 154 identifies the snapshot that is closest to the selected point in time and also prior to the selected point in time.

In step 308, backup controller 154 selects an extent of the identified snapshot. In step 310, backup controller 154 determines whether this extent of the logical volume has changed in the time between this snapshot and a previous snapshot. This is indicated whenever a flag for the extent is set. If an extent of the snapshot stores data but does not have a set flag, then backup controller 154 can quickly determine that the data stored is irrelevant with respect to the rebuild.

If the flag is not set, then processing continues to step 312, where a snapshot immediately prior to the currently used snapshot is selected. The flag for the extent of this newly selected snapshot is then checked in step 310, and so on. However, if the flag is set for the extent, processing continues to step 314 and the data is added to the rebuild data. Note that if the identified snapshot is a baseline snapshot, since there are no previous snapshots, the data at the logical volume is considered “changed” and the flags are set for each extent. After the rebuild data is added, processing continues to step 308 and a new extent of the identified snapshot (i.e., the snapshot prior to the point in time that is also closest to the point in time) is selected.

This process may continue until data for each extent has been selected for the rebuild. For example, the rebuild may use, on an extent by extent basis, the most-recent data stored for each extent that also has a set flag. Using this method, the rebuild process is not “tricked” into including data that was never a part of the logical volume in the first place.

In some scenarios, a user may remove snapshots that have been created. In the case where a snapshot is removed from the backup system, the snapshots before and after the one being removed may have their sharing data updated in order to properly reference each other (sharing data is further described with regard to the examples discussed below). Furthermore, if the snapshot being removed includes stored data from the logical volume and not just pointers, then this snapshot data may be copied to a previous (or later) snapshot for storage. For example, in one embodiment data for each extent is copied to the previous snapshot so long as it does not overwrite already-existing data on the previous snapshot. In one embodiment, if data is copied from to another snapshot, the flags for that data are copied to the other snapshot as well.

The following details specifically illustrate removal of backup snapshots in an exemplary embodiment. On removal of a baseline backup snapshot, the first successive incremental backup snapshot is promoted to be (and hence is designated as) the new baseline backup snapshot. The tracking structures are updated accordingly. In the absence of any successive incremental backup snapshot, the active logical volume itself becomes the baseline or complete backup. This is indicated in the algorithm below, wherein the Sb bitmap corresponds with the flags for a snapshot:

```
If a subsequent incremental backup snapshot (Ij) exists:
    Set entire Ij.Sb bitmap
    Designate Ij as the new baseline snapshot
Else:
    Set entire LogicalVolume.Sb bitmap
```

On removal of an incremental backup snapshot (ID, the subsequent incremental backup snapshot “inherits” the backup information from the current incremental backup snapshot being deleted. If there is no subsequent incremental backup snapshot, then the active logical volume inherits the backup information from the current incremental backup snapshot being deleted. This is indicated in the algorithm below (here, OR indicates a logical operation):

```
If there exists a subsequent incremental backup snapshot (Ik):
    Ik.Sb bitmap = (Ik.Sb bitmap) OR (Ij.Sb bitmap)
Else:
    LogicalVolume.Sb bitmap = (LogicalVolume.Sb bitmap) OR
    (Ij.Sb bitmap)
```

### Examples

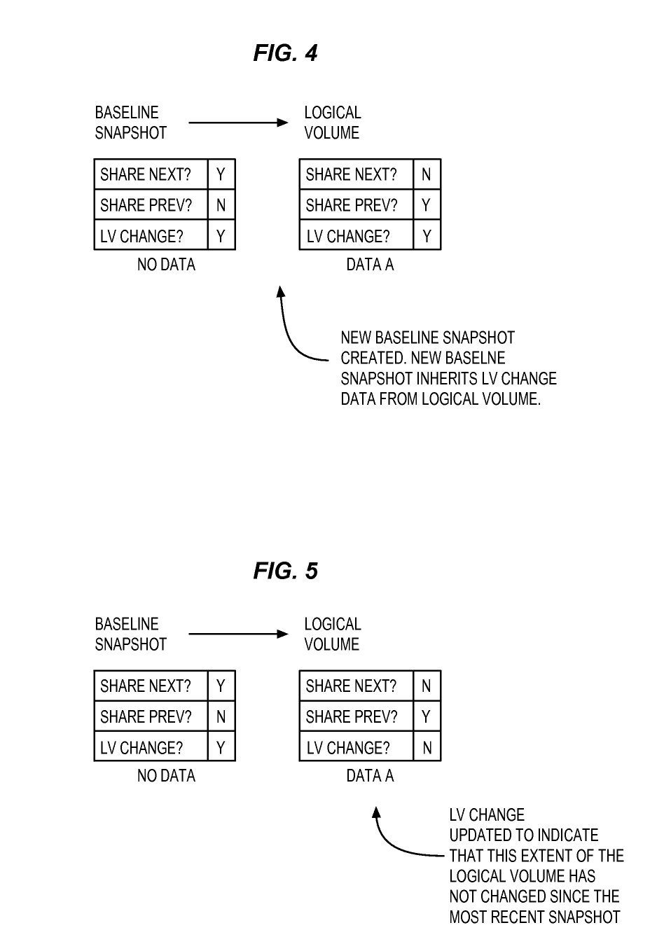

FIGS. 4-12 are block diagrams illustrating the creation and maintenance of multiple Copy-On-Write snapshots of a logical volume in an exemplary embodiment. In these FIGS., special “Logical Volume (LV) Change” flags are added to the snapshots of a volume in order to track the specific changes made to the volume over time.

In FIG. 4, a single extent (e.g., an extent of 4 megabytes in size) of a logical volume is shown on the right, and a baseline snapshot of the extent is shown on the left. The extent of the logical volume includes “DATA A,” while the extent of the baseline snapshot does not include any data from the extent—it merely points to the extent as it is stored in the logical volume. Along with each extent is a set of three different bits. The first bit, “Share Next,” indicates whether this extent of the volume/snapshot depends on a later snapshot for its data. Here, the baseline snapshot depends on the data stored in the logical volume, so the bit is set for the baseline snapshot. The second bit, “Share Prev,” indicates whether data stored in the present snapshot is relied upon by an earlier snapshot. Thus, for the baseline snapshot the bit is not set because there are no previous snapshots to share with. In contrast, for the logical volume, the bit is set because the data in the extent is shared with the baseline snapshot.

The third bit is the Logical Volume Change bit, “LV Change.” LV Change indicates whether the volume changed between the current snapshot and a previous snapshot. When the logical volume is first created, the LV Change bit is set for every extent by default. When the baseline snapshot is first created, as in FIG. 4, it takes a duplicate of the LV change data from the logical volume. Then, in FIG. 5, the LV change data for the logical volume is updated (i.e., cleared), to show that the logical volume (at least this extent of it) has not been changed since the previous snapshot (i.e., the baseline snapshot) was taken.

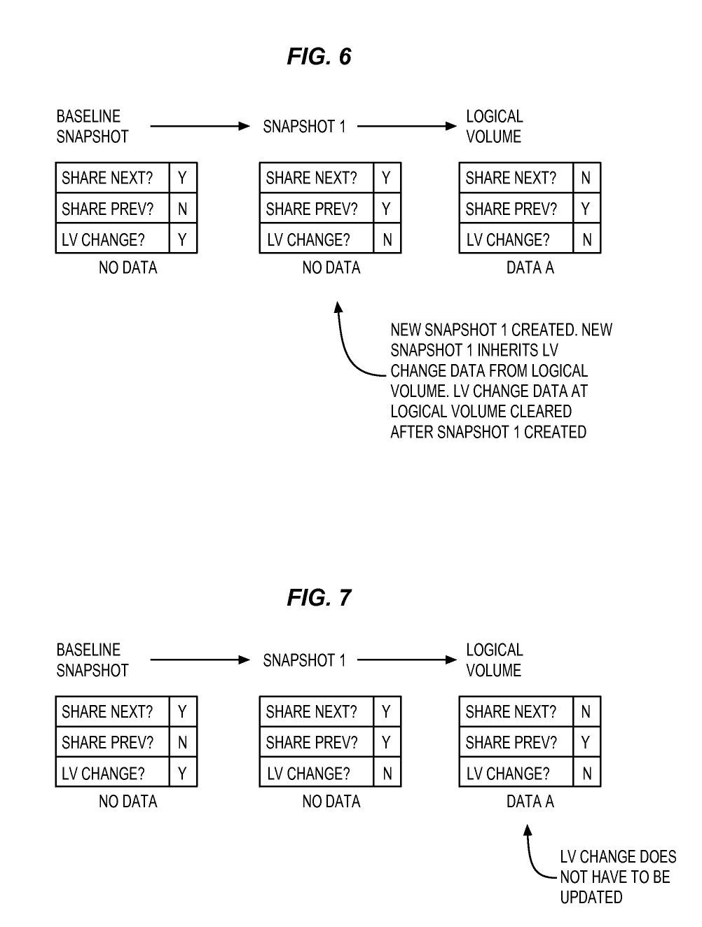

After a period of time, in FIG. 6, snapshot 1 is created. Because snapshot 1, just like the baseline snapshot, is Copy-On-Write, it starts by storing no data. Furthermore, the LV change bit is not set in snapshot 1, because it inherits the LV Change bit from the logical volume, and the logical volume has not changed since the previous snapshot (here, the baseline snapshot) was taken. Since both the baseline snapshot and snapshot 1 refer to the same data stored in the logical volume (which has not yet changed), they use the Share Next and Share Prev bits to form a “chain of sharing” between each other and the logical volume. FIG. 7 shows that, since no changes have taken place to the data stored on the logical volume or any snapshot, the LV Change bit at the logical volume does not have to be updated (i.e., cleared again) at this time.

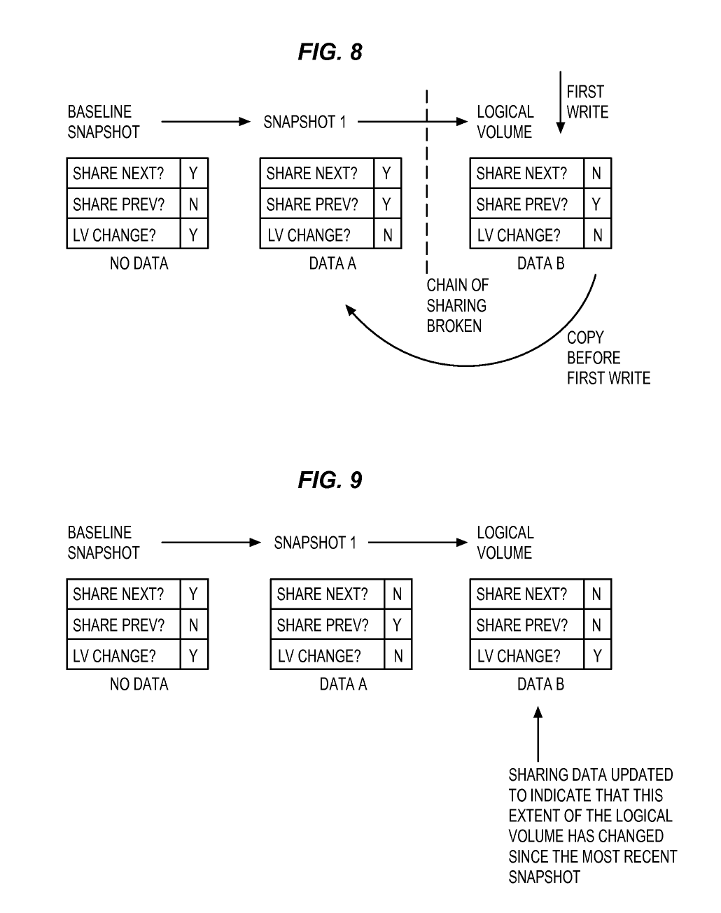

FIG. 8 illustrates a situation where a write modifies data stored at this extent of the logical volume. Here, the write is the first write to modify this extent of the logical volume since the last snapshot (snapshot 1) was taken. Therefore, DATA A for the extent is copied to snapshot 1 before new DATA B overwrites it. Once this occurs, the Share Next and Share Prev bits are updated in FIG. 9 to indicate that the chain of sharing has been broken between the logical volume and snapshot 1. Furthermore, the LV Change bit at the logical volume is set to indicate that this extent of the logical volume has changed since snapshot 1 was taken.

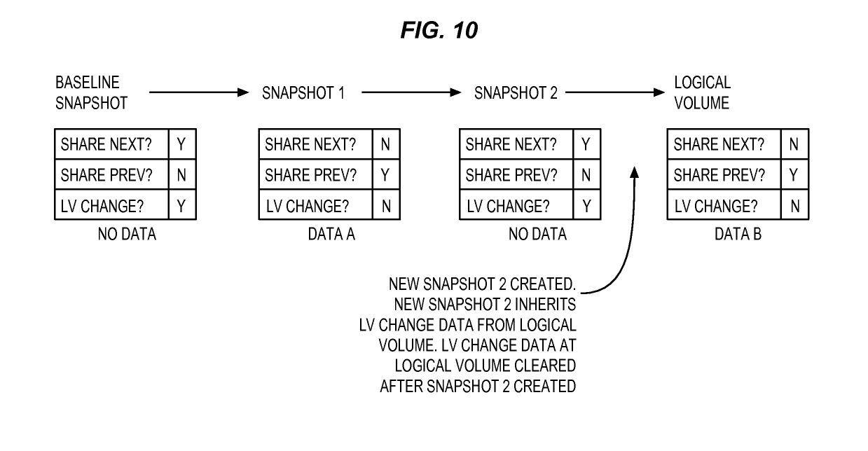

In FIG. 10, snapshot 2 is created for the logical volume. Here, this extent of snapshot 2 inherits the LV Change bit from the logical volume. The LV Change bit is then cleared at the logical volume, since this extent of the logical volume has not changed since snapshot 2 was taken.

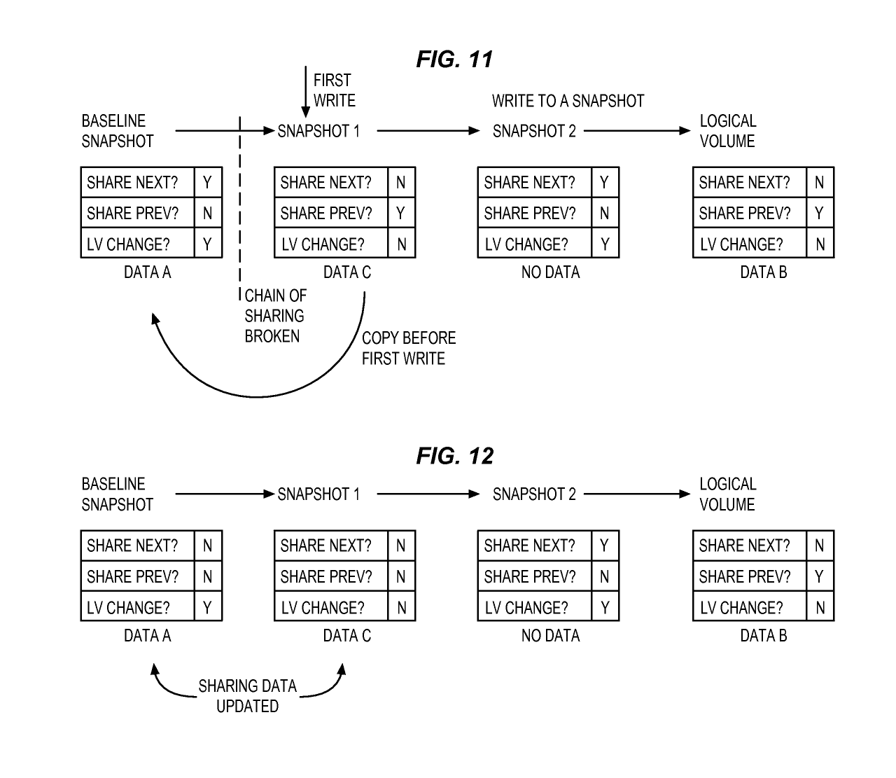

FIG. 11 illustrates the situation where an incoming write directly modifies existing data stored in a snapshot, without altering the logical volume itself. This can occur, for example, when a host wishes to alter the way that the logical volume acts when it is returned to a prior snapshot. Here, the incoming write breaks the chain of sharing between the baseline snapshot and snapshot 1. Thus, DATA A is backed up to the baseline snapshot before it is overwritten by DATA C. To reflect this change, sharing data (e.g., the Share Next bit and the Share Prev bit) is updated in FIG. 12 for the baseline snapshot and snapshot 1 to indicate that they no longer share data with each other.

In other systems, whenever a break is found in a chain of sharing, the default assumption is that the current extent of the logical volume was changed between the times that the snapshots were taken. However, here, because the LV Change bit for snapshot 1 is cleared, a backup controller can instantly determine that DATA C in snapshot 1 was never added to the logical volume at any point in time. Therefore, an accurate chronological history of the logical volume can be properly created, even though incoming write may modify data stored in some of the snapshots of the logical volume.

In a further embodiment, if a user decides to alter a snapshot that is used for backup, the entire snapshot is removed from the backup system (so that it is no longer used during rebuild). In this case, the backup information in the backup snapshot that is being removed is merged into a successor backup snapshot. Such processes for snapshot removal are discussed above.

In another embodiment, alterations to any snapshots that are listed as backup snapshots are prevented by the backup system in order to maintain data integrity. In such cases, the backup snapshots can become “read-only” snapshots. In this case, the flags in each snapshot still indicate “incremental” changes in the logical volume with respect to the time that the incremental backup snapshot was created.

Furthermore, although the above figures have described the maintenance of sharing information for a single extent of logical volume data, the above principles can be applied to snapshots and logical volumes that have large numbers of extents.

In further embodiments, a host may attempt to directly modify an extent of a snapshot that has an LV Change bit that is already set. In such cases, it may be desirable to remove the snapshot entirely from the set of backup snapshots for the logical volume. The data for the extent that is stored in the snapshot and about to be overwritten (as well as the sharing data) may then be copied to a new snapshot, which takes the place of the old snapshot in the backup system. Using the new snapshot instead of the old one, it is still possible to determine not only whether the logical volume changed between two snapshots, but also how the logical volume changed.

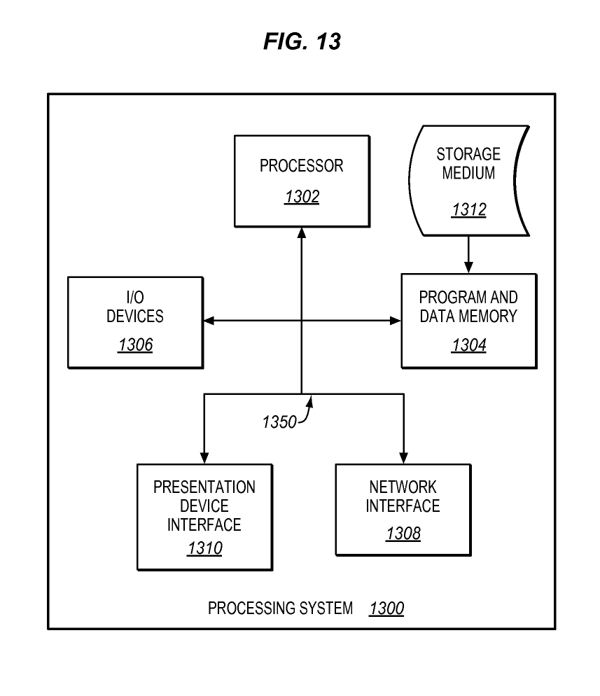

Embodiments disclosed herein can take the form of software, hardware, firmware, or various combinations thereof. In one particular embodiment, software is used to direct a processing system of a backup system to perform the various operations disclosed herein. FIG. 13 illustrates an exemplary processing system 1300 operable to execute a computer readable medium embodying programmed instructions. Processing system 1300 is operable to perform the above operations by executing programmed instructions tangibly embodied on computer readable storage medium 1312. In this regard, embodiments of the invention can take the form of a computer program accessible via computer readable medium 1312 providing program code for use by a computer or any other instruction execution system. For the purposes of this description, computer readable storage medium 1312 can be anything that can contain or store the program for use by the computer.

Computer readable storage medium 1312 can be an electronic, magnetic, optical, electromagnetic, infrared, or semiconductor device. Examples of computer readable storage medium 1312 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1300, being suitable for storing and/or executing the program code, includes at least one processor 1302 coupled to program and data memory 1304 through a system bus 1350. Program and data memory 1304 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1306 (including but not limited to keyboards, displays, pointing devices, etc.) can be coupled either directly or through intervening I/O controllers. Network adapter interfaces 1308 may also be integrated with the system to enable processing system 1300 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 1310 may be integrated with the system to interface to one or more presentation devices, such as printing systems and displays for presentation of presentation data generated by processor 1302.

What is claimed is:

1. A backup system for a Redundant Array of Independent Disks (RAID) storage system, the backup system comprising:
a backup storage device that includes Copy-On-Write snapshots of a logical volume of the storage system; and
a backup controller operable to maintain flags for the logical volume that indicate whether extents at the logical volume have been modified since a previous snapshot was created, and to move the flags from the logical volume to a new Copy-On-Write snapshot of the volume when the new Copy-On-Write snapshot is created.

2. The system of claim 1 wherein:
the backup controller is further operable to rebuild the logical volume by detecting extents of snapshots that have set flags, and copying data from the detected extents to rebuild data for the logical volume.

3. The system of claim 1 wherein:
the flags for each snapshot form a bitmap, where each bit in the bitmap is a flag for a different extent of the logical volume.

4. The system of claim 3 wherein:
each snapshot further comprises a previous sharing bitmap, where each bit in the previous sharing bitmap corresponds with a different extent of the logical volume, and indicates whether data for the corresponding extent is shared with a previous snapshot.

5. The system of claim 3 wherein:
each snapshot further comprises a subsequent sharing bitmap, where each bit in the subsequent sharing bitmap corresponds with a different extent of the logical volume, and indicates whether data for the corresponding extent is shared with a subsequent snapshot.

6. The system of claim 1 wherein:
the backup controller is further operable to detect an incoming write operation to an extent of the logical volume, and to copy the extent to one or more Copy-On-Write snapshots before applying the write to the extent.

7. The system of claim 1 wherein:
the backup controller is further operable to detect an incoming Input/Output operation directed to an extent of a snapshot, and to modify the extent as it resides at the snapshot.

8. The system of claim 1 wherein:
the backup controller is further operable to maintain the flags for the volume by detecting incoming Input/Output operations directed to extents of the logical volume, and setting corresponding flags if the Input/Output operations will modify the extents.

9. A method for backing up a Redundant Array of Independent Disks (RAID) logical volume, comprising:
identifying an incoming Input/Output operation that will modify an extent of a logical volume;
setting a flag for the extent at the logical volume if the extent has been modified at the logical volume since a previous Copy-On-Write snapshot of the volume was created;
creating a new Copy-On-Write snapshot of the logical volume; and
moving the flags from the volume to the new Copy-On-Write snapshot of the volume when the new Copy-On-Write snapshot is created.

10. The method of claim 9 further comprising rebuilding the logical volume by:
detecting extents of snapshots that have set flags; and
copying data from the detected extents to rebuild data for the logical volume.

11. The method of claim 9 wherein:
the flags for each snapshot form a bitmap, where each bit in the bitmap is a flag for a different extent of the logical volume.

12. The method of claim 11 wherein:
each snapshot further comprises a previous sharing bitmap, where each bit in the previous sharing bitmap corresponds with a different extent of the logical volume, and indicates whether data for the corresponding extent is shared with a previous snapshot.

13. The method of claim 11 wherein:
each snapshot further comprises a subsequent sharing bitmap, where each bit in the subsequent sharing bitmap corresponds with a different extent of the logical volume, and indicates whether data for the corresponding extent is shared with a subsequent snapshot.

14. The method of claim 9 further comprising:
detecting an incoming write operation to an extent of the logical volume; and
copying the extent to one or more Copy-On-Write snapshots before applying the write to the extent.

15. The method of claim 9 further comprising:
detecting an incoming Input/Output operation directed to an extent of a snapshot; and
modifying the extent as it resides at the snapshot.

16. A non-transitory computer readable medium embodying programmed instructions which, when executed by a processor, are operable for performing a method for backing up a Redundant Array of Independent Disks (RAID) volume, the method comprising:
identifying an incoming Input/Output operation that will modify an extent of a logical volume;
setting a flag for the extent at the logical volume if the extent has been modified at the logical volume since a previous Copy-On-Write snapshot of the volume was created;
creating a new Copy-On-Write snapshot of the logical volume; and
moving the flags from the volume to the new Copy-On-Write snapshot of the volume when the new Copy-On-Write snapshot is created.

17. The medium of claim 9, the method further comprising rebuilding the logical volume by:
detecting extents of snapshots that have set flags; and
copying data from the detected extents to rebuild data for the logical volume.

18. The medium of claim 9 wherein:
the flags for each snapshot form a bitmap, where each bit in the bitmap is a flag for a different extent of the logical volume.

19. The medium of claim 18 wherein:
each snapshot further comprises a previous sharing bitmap, where each bit in the previous sharing bitmap corresponds with a different extent of the logical volume, and indicates whether data for the corresponding extent is shared with a previous snapshot.

20. The medium of claim 18 wherein:
each snapshot further comprises a subsequent sharing bitmap, where each bit in the subsequent sharing bitmap corresponds with a different extent of the logical volume, and indicates whether data for the corresponding extent is shared with a subsequent snapshot.
